(19) United States
(12) Patent Application Publication
(10) Pub. No.: US 2010/0006259 A1
(43) Pub. Date: Jan. 14, 2010

(54) LAPTOP ACCESSORY AND METHOD OF MANUFACTURE

(75) Inventors: Kenneth Mori, Los Angeles, CA (US); Barry Sween, Santa Monica, CA (US)

Correspondence Address: BRYAN CAVE LLP, TWO NORTH CENTRAL AVENUE, SUITE 2200, PHOENIX, AZ, 85004, US

(73) Assignee: Belkin International, Inc, Compton, CA (US)

(21) Appl. No.: 12/468,862

(22) Filed: May 19, 2009

Related U.S. Application Data
(60) Provisional application No. 61/054,365, filed on May 19, 2008.

(51) Int. Cl. F28F 9/007; F16M 13/00

(52) U.S. Cl. 165/67; 248/346.4

(57) ABSTRACT

An article having a support base and multiple nodules arranged in an array can be placed under part of a laptop computer to promote cooling of the computer. Nodules may be spaced to hold cords or may contain slots for cords. There may be one or more rows of modules which may be off set and may vary in height. Materials may be selected to conduct heat. Methods include obtaining or providing articles, advertising use under laptop computers, and selling the articles.

### CROSS REFERENCE TO RELATED APPLICATION

This application claims priority to U.S. Provisional Patent Application 61/054,365, filed on May 19, 2008, the contents of which are incorporated herein by reference.

### FIELD OF THE INVENTION

This invention relates generally to the field of laptop computers, and relates, more particularly, to apparatuses for supporting and cooling a laptop computer and related methods.

### BACKGROUND

As laptop computers have become more miniaturized, such as for example through the use of injectable metals (e.g., metal alloys) over plastics as a way to reduce case wall thickness, heat retention has become an issue. Such heat residing within a laptop can reduce internal component performance as well as internal component lifetime, and hence, user experience. Additionally, many locations on the laptop case can become uncomfortably hot to the human skin, including the area near the battery storage compartment which is typically located on the underside of the laptop near the laptop screen.

Therefore, a need exists in the art to develop an apparatus to reduce the temperature of the underside of a laptop as well as related methods that address such limitations of the current technology.

### BRIEF DESCRIPTION OF THE DRAWINGS

The invention will be better understood from a reading of the following detailed description of examples of embodiments, taken in conjunction with the accompanying figures in the drawings in which:

FIG. 1 illustrates a side view of an exemplary operational system for providing an improved user experience, in accordance with the subject matter described herein.

FIG. 2 illustrates an isometric close-up view of the exemplary laptop accessory for providing user an improved user experience of FIG. 1, in accordance with the subject matter described herein.

FIG. 3 illustrates a top-down view of the exemplary laptop accessory for providing user an improved user experience of FIG. 1, in accordance with the subject matter described herein.

FIG. 4 illustrates a frontal view of the exemplary laptop accessory for providing user an improved user experience of FIG. 1, in accordance with the subject matter described herein.

FIG. 5 illustrates a side view of the exemplary laptop accessory for providing user an improved user experience of FIG. 1, in accordance with the subject matter described herein.

FIG. 6 illustrates a side view of another exemplary operational system for providing an improved user experience, in accordance with the subject matter described herein.

FIG. 7 illustrates an isometric close-up view of the exemplary operational system, including a power cord, for providing an improved user experience of FIG. 7, in accordance with the subject matter described herein.

FIG. 8 illustrates a three-quarter view of yet another exemplary operational system for providing an improved user experience, in accordance with the subject matter described herein.

FIG. 9 illustrates a close up view of the cable management portion of still another exemplary operational system for providing an improved user experience, in accordance with the subject matter described herein.

FIG. 10 illustrates a close up view of the cable management portion of still yet another exemplary operational system for providing an improved user experience, in accordance with the subject matter described herein.

FIG. 11 illustrates a close up view of the cable management portion of another exemplary operational system for providing an improved user experience, in accordance with the subject matter described herein.

FIG. 12 illustrates a side view of yet another exemplary operational system for providing an improved user experience, in accordance with the subject matter described herein.

FIG. 13 illustrates a side view of still another exemplary operational system for providing an improved user experience, in accordance with the subject matter described herein.

FIG. 14 is a flow chart illustrating a method of cooling lap-top computers.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

The terms “couple,” “coupled,” “couples,” “coupling,” and the like should be broadly understood and refer to connecting two or more elements or signals, electrically, mechanically or otherwise. Two or more electrical elements may be electrically coupled, but not mechanically or otherwise coupled; two or more mechanical elements may be mechanically coupled, but not electrically or otherwise coupled; two or more electrical elements may be mechanically coupled, but not electrically or otherwise coupled. Coupling (whether mechanical, electrical, or otherwise) may be for any length of time, e.g., permanent or semi-permanent or only for an instant.

“Electrical coupling” and the like should be broadly understood and include coupling involving any electrical signal, whether a power signal, a data signal, and/or other types or combinations of electrical signals. “Mechanical coupling” and the like should be broadly understood and include mechanical coupling of all types. The absence of the word “removably,” “removable,” and the like near the word “coupled,” and the like does not mean that the coupling, etc. in question is or is not removable.

### DETAILED DESCRIPTION

In one embodiment, a portable computing device accessory is provided. The portable computing device can include: (a) a support base, and (b) a plurality of spaced nodules projecting from the support base and arranged in an array, each nodule having at least a nodule base physically coupled to the support base and a support portion coupled to the nodule base and distil to the support base.

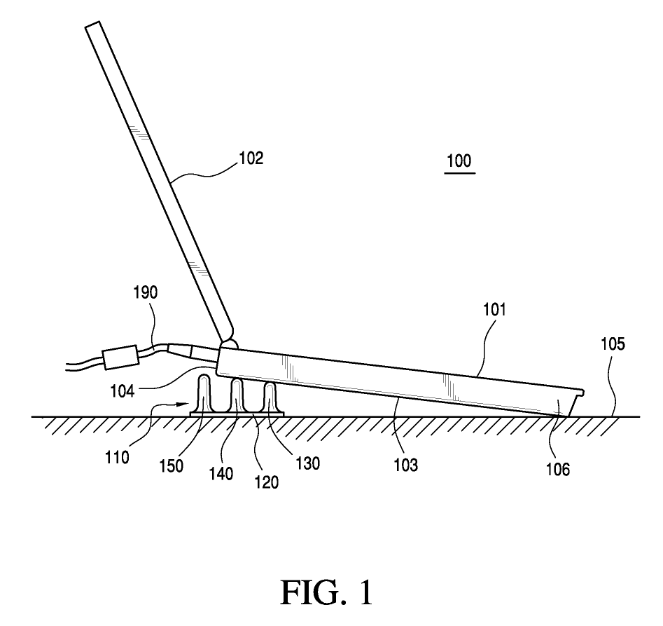

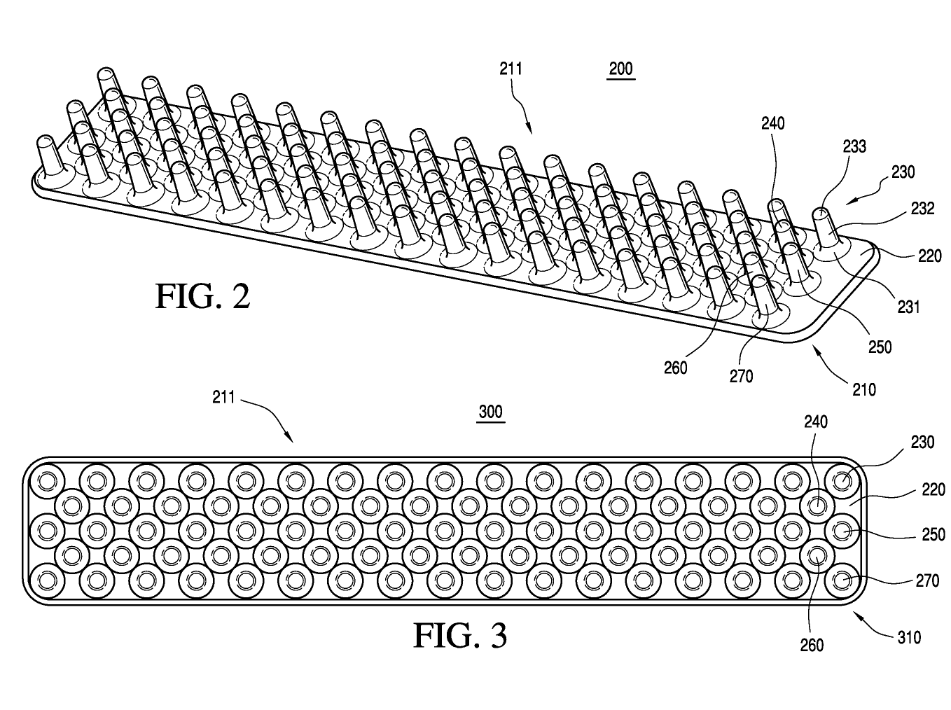

Turning to the drawings, FIG. 1 illustrates a side view of a portable mobile computer cooling system 100 for providing an improved user experience. Portable mobile computer cooling system 100 includes a portable computing device 101 having a portable power cord 190 attached to provide power to portable computing device 101, surface 105 upon which portable computing device 101 partially rests, and a portable cooling support strip 110 also resting on surface 105 and supporting portable computing device 101. Portable computing device 101 includes a laptop base 103 and a screen 102. Laptop base 103 of portable computing device 101 includes a front portion 106 and a rear portion 104. Portable cooling support strip 110 includes a support strip base 120 and a plurality of nodules 130, 140 and 150 arranged in an array to support a portion of portable computing device 101 above surface 105. Nodules 130, 140 and 150 are detailed in FIGS. 2-5 below. In some embodiments, portable mobile computer cooling system 100 is implemented as including portable computing device 101 without portable power cord 190 attached and actively providing power to portable computing device 101.

In operation, portable cooling support strip 110 provides support for rear portion 104 of portable computing device 101. In such embodiments, rear portion 104 of laptop base 103 of portable computing device 101 rests on the nodules of portable cooling support strip 110 thereby lifting laptop base 103 of portable computing device 101 away from surface 105.

FIG. 2 illustrates an isometric close-up view of a portable mobile computer cooling system 200 for providing an improved user experience. Portable mobile computer cooling system 200 includes portable cooling support strip 210 that includes a support strip base 220 and a plurality of nodules 230, 240, 250, 260 and 270 as well as other nodules, arranged in an array 211. In some embodiments, array 211 is arranged in a substantially rectangular shape including m-rows and n-columns. Although there are approximately eighty-three (83) nodules contained within portable cooling support strip 210, a single nodule, nodule 230, will be detailed as the remaining nodules are substantially similar to nodule 230 differing only in location within the array 211 of support strip base 220. Each nodule, for example nodule 230, of array 211 includes a nodule base 231 that is mechanically coupled to support strip base 220, a nodule finger 232 coupled to nodule base 231, and a nodule head 233 coupled to nodule finger 232. In some embodiments, each of the portions of nodule 230 are together formed as a single piece. In other embodiments, support strip base 220 and all or some portions of nodule 230 are together formed as a single piece. In yet other examples, a row can contain a single raised portion that runs the length of the row. In the same or other examples, if the row is one single raised portion, the row can have slots for the placement of cords from the laptop, or other similar cords.

Each nodule, for example nodule 230, can have any diameter that will support a typical laptop computer. In some examples, nodule 230 can have an approximately 8.5 mm diameter at nodule base 231. In addition, in the same or other examples, nodule 230 can have an approximately 6.0 mm diameter at nodule head 233. In some examples individual nodules may have different diameters than other nodules. In addition, the nodules can be spaced apart from one another so that cooling support strip will support a laptop computer. As an example, the space between the nodules can range from approximately 10 mm to approximately 25 mm. In the same or other examples, nodules can be spaced approximately 22.5 mm apart in one direction (along an x-axis), while being spaced apart by 11.25 mm in the other direction (along a y-axis).

In FIG. 2, the nodules of cooling support strip 210 are arranged in an array of rows and columns. In some embodiments, array 211 is arranged as five (5) rows with the number of columns varying. In this embodiment, the odd numbered rows (e.g., 1, 3 and 5) associated with nodules 230, 250 and 270 include seventeen (17) nodules and the even numbered rows (e.g., 2 and 4) associated with nodules 240 and 260 include sixteen (16) nodules and are offset from the odd numbered rows. This array configuration results in a staggered grouping of nodules within cooling support strip 210. In other embodiments, the array includes five (5) rows and seventeen (17) columns arranged in a substantially rectangular array. In yet other embodiments, the number of rows and columns may be completely different. In yet still other embodiments, the array may be arranged as one or more other geometric shapes or may be arranged such as to resemble no geometric shape.

In some embodiments, cooling support strip 210 is of adequate size to cover the width of a typical laptop computer. For example, the width of cooling support strip 210 can be approximately 385 millimeters (mm). In other examples the width of cooling support strip 210 can be approximately 300 mm, 325 mm, 350 mm, 375 mm, or 400 mm.

Cooling support strip 210 can be long enough so that at least a portion of cooling support strip can be positioned under a portion of a typical laptop computer. For example, the length of cooling support strip 210 can be approximately 65 mm. In other examples, the length of cooling support strip 210 can be approximately 55 mm, 60 mm, 70 mm, 75 mm.

Cooling support strip 210 can be high enough to provide support for a typical laptop computer. For example, the height of cooling support strip can be approximately 25 mm. In other examples, the height of cooling support strip 210 can be approximately 20 mm or 30 mm.

Cooling support strip 210 can comprise many different materials. For example, cooling support strip 210 and the associated nodules can comprise a thermosetting polymer with a soft durometer, a thermosetting polymer with a hard durometer, a thermoplastic polymer with a soft durometer, a thermoplastic polymer with a hard durometer, a metal, or ceramics.

FIG. 3 illustrates a top-down view of a portable mobile computer cooling system 300 for providing an improved user experience. Portable mobile computer cooling system 300 includes portable cooling support strip 310 that includes a support strip base 220 and a plurality of nodules 230, 240, 250, 260 and 270 as well as other nodules, arranged in an array 211. Elements numbered as in FIG. 2 function in a substantially similarly way. Array 211 of FIG. 3 illustrates a substantially rectangular array of nodules including staggered even rows (e.g., nodules in the row associated with nodules 240 and 260) as described in array 211 of FIG. 2, above.

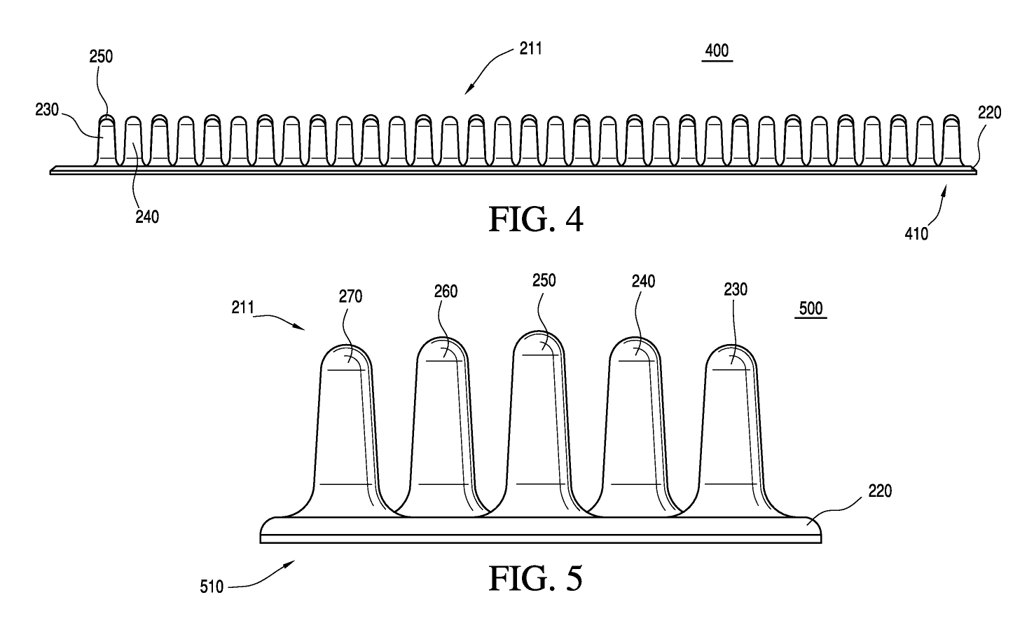

FIG. 4 illustrates a front view of a portable mobile computer cooling system 400 for providing an improved user experience. Portable mobile computer cooling system 400 includes portable cooling support strip 410 that includes a support strip base 220 and a plurality of nodules 230, 240 and 250 as well as other nodules, arranged in an array 211. Elements numbered as in FIG. 2 function in a substantially similarly way. Array 211 of FIG. 4 illustrates a substantially rectangular array of nodules including staggered even rows (e.g., nodules in the row associated with nodule 240) as described in array 211 of FIGS. 2 and 3, above.

In FIG. 4, the row of nodules associated with nodule 240, one of the staggered rows of nodules, are each configured as having slightly greater height than the front row nodules associated with nodule 230. Similarly, the center row of nodules associated with nodule 250 are each configured as having slightly greater height than the nodules associated with nodule 240. In some embodiments, the tapering of each row to be slightly taller then the previous row results in an incline and may further result in a greater number of nodules contacting the laptop base of the portable computing device. Additionally, and as illustrated in FIG. 5 below, the include effect of the variable height of the rows results in the portable computing device being positioned in an ergonomically favorable configuration.

FIG. 5 illustrates a side view of a portable mobile computer cooling system 500 for providing an improved user experience. Portable mobile computer cooling system 500 includes portable cooling support strip 510 that includes a support strip base 220 and a plurality of nodules 230, 240, 250, 260 and 270 as well as other nodules, arranged in an array 211. Elements numbered as in FIG. 2 function in a substantially similarly way. Array 211 of FIG. 5 illustrates the differing height of the rows described in array 211 of FIG. 4 above.

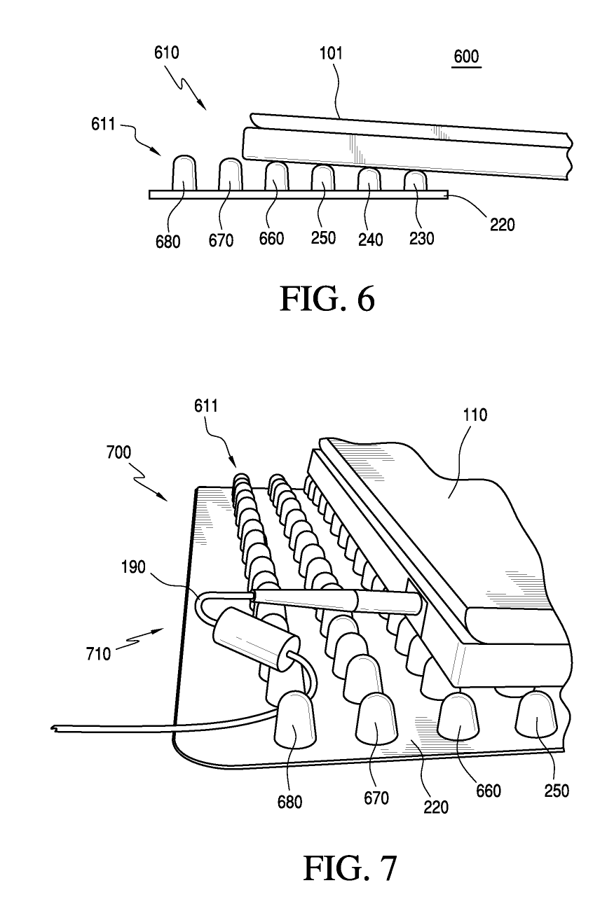

In FIG. 5, the row of nodules associated with nodule 240 are each configured as having slightly greater height than the front row nodules associated with nodule 230. Similarly, the row of nodules associated with nodule 250 are each configured as having slightly greater height than the row of nodules associated with nodule 240. In some embodiments, nodules associated with each successive row increase in height. Examples of these configurations are described in FIGS. 6-8 and 12. In other embodiments and illustrated in FIG. 5, the row of nodules associated with nodule 260 are each configured as having slightly lesser height than the row of nodules associated with nodule 250. Similarly, the row of nodules associated with nodule 270 are each configured as having slightly lesser height than the row of nodules associated with nodule 260.

In some embodiments, an arrangement of array 211 as illustrated in FIG. 5 results in the portable computing device being positioned in an ergonomically favorable configuration if placed on portable cooling support strip 510 from either direction. In some embodiments, the increase in height between the nodules within the row associated with nodule 230 and the nodules within the row associated with nodule 250 and the increase in height between the nodules within the row associated with nodule 270 and the nodules within the row associated with nodule 250 is approximately three degrees (3°).

FIG. 6 illustrates a side view of a portable mobile computer cooling system 600 for providing an improved user experience. Portable mobile computer cooling system 600 includes portable cooling support strip 610 and portable computing device 101. Portable cooling support strip 610 includes a support strip base 220 and a plurality of nodules 230, 240, 250, 660, 670 and 680 as well as other nodules, arranged in an array 611. Elements numbered as in FIGS. 1 and 2 function in a substantially similarly way.

Array 611 of FIG. 6 illustrates cooling support strip 610 configured as a wedge whereby each successive row from the nodules within the row associated with nodule 230 to the nodules within the row associated with nodule 680 (i.e., front-to-back) increase in height. In some embodiments, the increase in height is a uniform increase in height from row to row. In other embodiments, the increase in height from row to row is non-uniform. In one example, the increase in height from row to row is approximately three degrees (3°).

FIG. 7 illustrates a three-quarter rear view of a portable mobile computer cooling system 700 for providing an improved user experience. Portable mobile computer cooling system 700 includes portable cooling support strip 710 and portable computing device 101 having a portable power cord 190 attached to provide power to portable computing device 101. Portable cooling support strip 710 includes a support strip base 220 and a plurality of nodules 250, 660, 670 and 680 as well as other nodules, arranged in an array 611. Elements numbered as in FIGS. 1, 2 and 6 function in a substantially similarly way.

Portable cooling support strip 710 of FIG. 7 illustrates the functionality of cord management associated with portable cooling support strip 710 whereby a portion or portions of the cord or cable associated with portable power cord 190 can be wrapped around or wound between one or more nodules within array 611. In other embodiments, other cords or cables can be wrapped around or wound between one or more nodules within array 611. Examples of such cords or cables include mouse cords, keyboard cords, Ethernet cables and the like. In yet other embodiments, cords or cables having nothing to do with computing can be wrapped around or wound between one or more nodules within array 611, such as for decoration, recreation and the like.

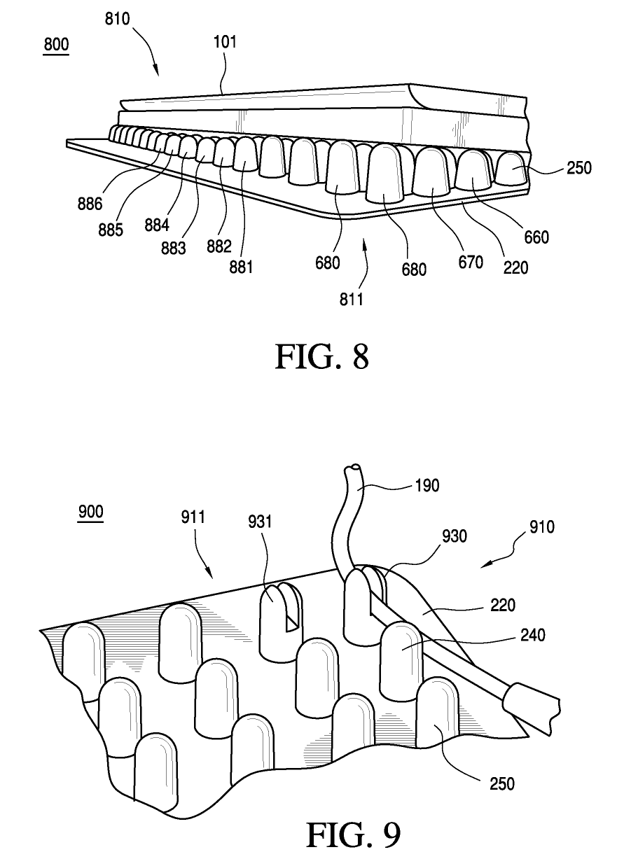

FIG. 8 illustrates a three-quarter rear view of a portable mobile computer cooling system 800 for providing an improved user experience. Portable mobile computer cooling system 800 includes portable cooling support strip 810 and portable computing device 101. Portable cooling support strip 810 includes a support strip base 220 and a plurality of nodules 250, 660, 670 and 680 as well as other nodules, arranged in an array 811. The row of nodules associated with nodule 680 includes, among other nodules, nodules 881-886. Elements numbered as in FIGS. 1, 2 and 6 function in a substantially similarly way.

Array 811 of FIG. 8 illustrates cooling support strip 810 configured as a wedge (front-to-back) whereby each successive row from the nodules within the row associated with nodule 250 to the nodules within the row associated with nodule 680 increase in height. Additionally, array 811 illustrates cooling support strip 810 configured to include a concave portion near the center (left-to-right). In some embodiments, the concavity is accomplished by each row (front-to-back) including several nodules starting at each end of the row maintaining a substantially similar height (e.g., four nodules per side) and then successive nodules decreasing in height by an amount, for example a uniform amount, until a base point is reached. In an example and referring to FIG. 8, the base point is illustrated by nodule 886.

FIG. 9 illustrates a close up view of a portable mobile computer cooling system 900 for providing an improved user experience. Portable mobile computer cooling system 900 includes portable cooling support strip 910 and portable power cord 190. Portable cooling support strip 910 includes a support strip base 220 and a plurality of nodules 930, 931, 240 and 250 as well as other nodules, arranged in an array 911. Elements numbered as in FIGS. 1 and 2 function in a substantially similarly way.

In FIG. 9, nodules 930 and 931 each includes a slot formed from the nodule head to the nodule finger and cut from one side of the nodule to the other side of the nodule. The slot is configured to receive a portion of portable power cord 190. In other embodiments, other cords or cables can be threaded through one or more similarly configured nodules, including the afore described slot, within array 911. Examples of such cords or cables include mouse cords, keyboard cords, Ethernet cables and the like. In yet other embodiments, cords or cables having nothing to do with computing can be threaded through one or more nodules within array 911, such as for decoration, recreation and the like.

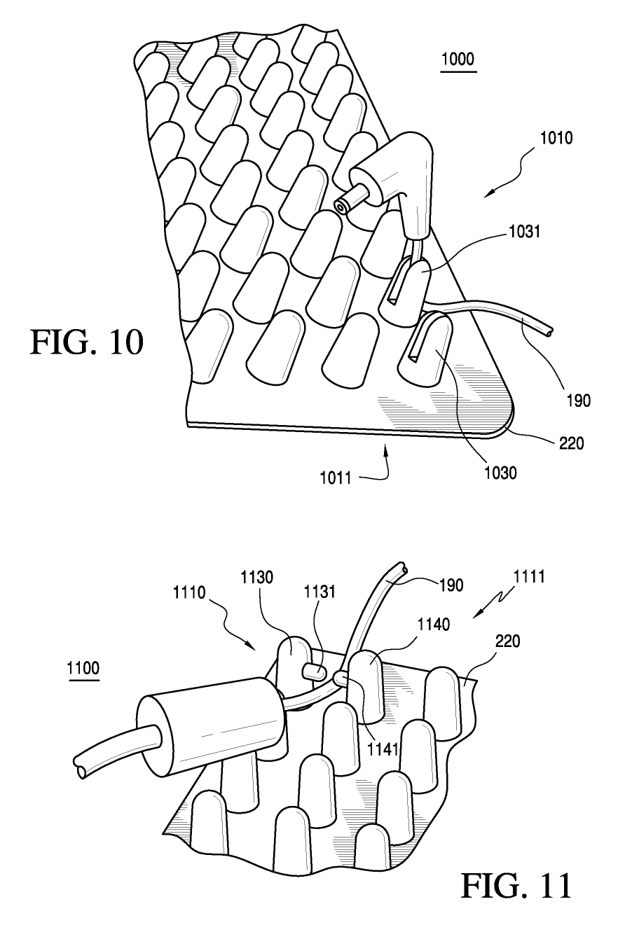

FIG. 10 illustrates a close up view of a portable mobile computer cooling system 1000 for providing an improved user experience. Portable mobile computer cooling system 1000 includes portable cooling support strip 1010 and portable power cord 190. Portable cooling support strip 1010 includes a support strip base 220 and a plurality of nodules 1030 and 1031 as well as other nodules, arranged in an array 1011. Elements numbered as in FIGS. 1 and 2 function in a substantially similarly way.

In FIG. 10, nodule 1031 includes a slot formed from the nodule head to the nodule finger and cut from one side of the nodule. The slot is configured to receive a portion of portable power cord 190, preferably a portion of portable power cord 190 near the male DC connector. In other embodiments, other cords or cables can be threaded through one or more similarly configured nodules, including the afore described slot, within array 1011. Examples of such cords or cables include mouse cords, keyboard cords, Ethernet cables and the like. In yet other embodiments, cords or cables having nothing to do with computing can be threaded through one or more nodules within array 1011, such as for decoration, recreation and the like.

FIG. 11 illustrates a close up view of a portable mobile computer cooling system 1100 for providing an improved user experience. Portable mobile computer cooling system 1100 includes portable cooling support strip 1110 and portable power cord 190. Portable cooling support strip 1110 includes a support strip base 220 and a plurality of nodules 1130 and 1140 as well as other nodules, arranged in an array 1111. Elements numbered as in FIGS. 1 and 2 function in a substantially similarly way.

In FIG. 11, nodule 1130 includes a nub 1131 formed along the nodule finger and nodule 1140 includes a nub 1141 formed along the nodule finger opposite nub 1131 associated with nodule 1130. Nub 1131 associated with nodule 1130 and nub 1141 associated with nodule 1140 are configured to receive a portion of portable power cord 190. In some embodiments, a gap is maintained between nub 1131 and nub 1141 allowing portable power cord 190 to be threaded between the nubs 1131 and 1141 of the nodules within array 1111. Examples of such cords or cables include mouse cords, keyboard cords, Ethernet cables and the like. In yet other embodiments, cords or cables having nothing to do with computing can be threaded through one or more nodules within array 1111, such as for decoration, recreation and the like.

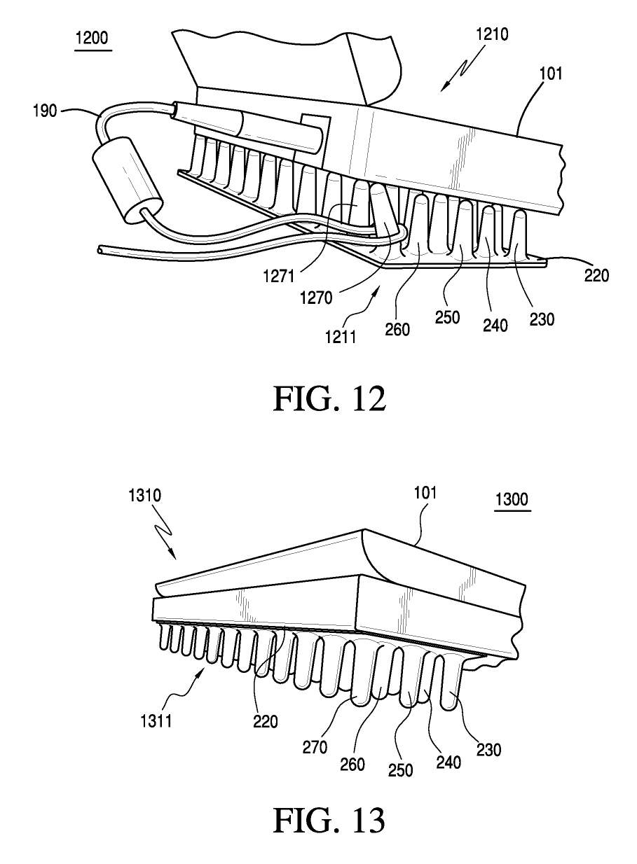

FIG. 12 illustrates a three-quarter rear view of a portable mobile computer cooling system 1200 for providing an improved user experience. Portable mobile computer cooling system 1200 includes portable cooling support strip 1210 and portable computing device 101 having a portable power cord 190 attached to provide power to portable computing device 101. Portable cooling support strip 1210 includes a support strip base 220 and a plurality of nodules 230, 240, 250, 260, 1270 and 1271, as well as other nodules, arranged in an array 1211. Elements numbered as in FIGS. 1 and 2 function in a substantially similarly way.

Portable cooling support strip 1210 of FIG. 12 illustrates the functionality of cord management associated with portable cooling support strip 1210 whereby a portion or portions of the cord or cable associated with portable power cord 190 can be wrapped around or wound between one or more nodules within array 1211. In some embodiments and illustrated in FIG. 12, when the nodules, for example nodules 1270 and 1271 of array 1211 are manufactured from certain pliable materials (e.g., the silicone material listed in FIG. 3, above) the nodules are elastic and may be manipulated as depicted in FIG. 12. In other embodiments, some or all of the nodules are manufactured from pliable materials.

In still other embodiments, other cords or cables can be wrapped around or wound between one or more nodules within array 1211. Examples of such cords or cables include mouse cords, keyboard cords, Ethernet cables and the like. In yet other embodiments, cords or cables having nothing to do with computing can be wrapped around or wound between one or more nodules within array 1211, such as for decoration, recreation and the like.

FIG. 13 illustrates a three-quarter rear view of a portable mobile computer cooling system 1300 for providing an improved user experience. Portable mobile computer cooling system 1300 includes portable cooling support strip 1310 and portable computing device 101 having a portable power cord 190 attached to provide power to portable computing device 101. Portable cooling support strip 1310 includes a support strip base 220 and a plurality of nodules 230, 240, 250, 260 and 270 as well as other nodules, arranged in an array 1311. Elements numbered as in FIGS. 1 and 2 function in a substantially similarly way.

Array 1311 of FIG. 13 illustrates the front portion of cooling support strip 1310 is configured as an inverted wedge whereby each successive row from the nodules within the row associated with nodule 230 to the nodules within the row associated with nodule 250 (i.e., front-to-middle) increase in height. In FIG. 13, the rear portion of cooling support strip 1310 is also configured as an inverted wedge whereby each successive row from the nodules within the row associated with nodule 270 to the nodules within the row associated with nodule 250 (i.e., back-to-middle) increase in height. In some embodiments, the increase in height is a uniform increase in height from row to row. In other embodiments, the increase in height from row to row is non-uniform. In one example, the increase in height from row to row is approximately three degrees (3°).

In FIG. 13, the increase in height of the rows of nodules allows for a portion of support strip base 220 to maintain contact with portable computing device 101 and allows cooling support strip 1310 to conduct heat from portable computing device 101 when cooling support strip 1310 is constructed from heat conducting materials, such as some of the materials listed in FIG. 2, above. In one embodiment, cooling support strip 1310 is constructed from a thermally conductive thermoplastic elastomer (TPE) from RTP Company of Winona, Minn.

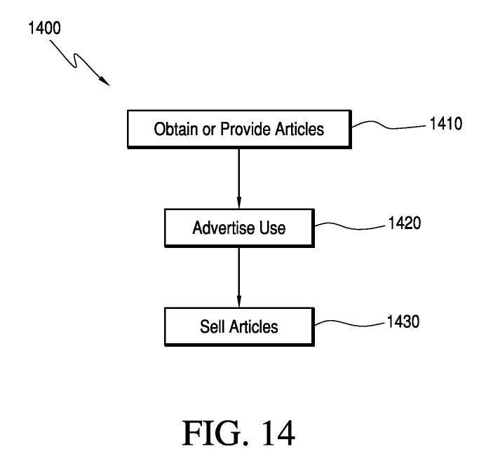

Also provided are various methods including methods of obtaining or providing various structure described herein, and methods of using articles as described herein. FIG. 14 illustrates various examples of methods of cooling lap-top computers, for example. In a number of embodiments, methods may include, for example, in any order, at least certain acts, which may be described herein. In FIG. 14, method 1400 comprises acts of obtaining or providing articles (act 1410), advertising use of the articles (act 1420), and selling the articles (act 1430), as examples.

Specifically, some embodiments may include an act of obtaining or providing multiple articles (act 1410), each article having a substantially flat base having a first side and a second side, wherein the first side is substantially flat and the second side comprises, for instance, multiple nodules projecting from the second side and arranged in an array (e.g., as described herein). Such articles may be manufactured, for example, or purchased from suppliers, or may be provided to suppliers or retail establishments, as examples. In a number of embodiments, the act of obtaining or providing multiple articles (e.g., 1410) includes providing articles wherein the array includes multiple rows and wherein, for at least a portion of each article, a height of each successive row of spaced nodules is greater than a height of a preceding row (e.g., as shown in FIG. 5). Further still, in particular embodiments, the act of obtaining or providing multiple articles (e.g., 1410) comprises obtaining or providing articles wherein the base and the nodules are a single object, for example.

Various embodiments also include advertising (e.g., act 1420) that the articles can be placed under at least a portion of a lap top computer used to promote cooling of the lap top computer, or both. Advertising may be performed through the media (e.g., on television or radio), in magazines, through the Internet (e.g., on web pages describing product or Internet adds on pages primarily for another purpose), or through fliers, as other examples. In a number of embodiments, advertising may be performed in displays for products (e.g., for the articles) or on packaging for the articles. Advertising may include text or pictures showing the use, audio descriptions, or video, as examples. In certain embodiments, the act of advertising (e.g., act 1410) that the articles can be placed under at least a portion of a lap top computer comprises advertising that the article can be placed under a rear portion of the lap top computer so that a keyboard of the lap top computer is sloped downward toward a user of the lap top computer, for example.

Further, in some embodiments, the act of obtaining or providing multiple articles (e.g., 1410) comprises obtaining or providing articles having multiple nodules that each contain a slot (e.g., as shown in FIG. 9 or 10 for holding a cord, and in some embodiments, the act of advertising (e.g., 1420) includes advertising that at least one cord attached to the lap top computer can be managed by inserting the cord into at least one of the slots (e.g., by showing such a configuration in a photograph or drawing).

Articles may be sold (act 1430), for example, in retail establishments, in stores or departments where computers or computer accessories (or both) are sold, through the Internet, or by mail order, as examples. and selling the articles. Articles may be sold to the public or to distributors, retailers, or the like, as examples.

Although aspects of the subject matter described herein have been described with reference to specific embodiments, it will be understood by those skilled in the art that various changes may be made without departing from the scope of the subject matter described herein. Accordingly, the disclosure of embodiments is intended to be illustrative of the scope of the subject matter described herein and is not intended to be limiting. It is intended that the scope of the subject matter described herein shall be limited only to the extent required by the appended claims. To one of ordinary skill in the art, it will be readily apparent that the devices and method discussed herein may be implemented in a variety of embodiments, and that the foregoing discussion of certain of these embodiments does not necessarily represent a complete description of all possible embodiments. Rather, the detailed description of the drawings, and the drawings themselves, disclose at least one preferred embodiment, and may disclose alternative embodiments.

All elements claimed in any particular claim are essential to the subject matter described herein and claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A portable computing device accessory for supporting at least a portion of a portable computing device above a surface, comprising:
a support base, and
a plurality of spaced nodules projecting from the support base and arranged in an array, each nodule having at least a nodule base physically coupled to the support base and a support portion coupled to the nodule base and distil to the support base.

2. The portable computing device accessory of claim 1, wherein:
the support base is configured to rest on a portion of the surface; and
a first portion of the portable computing device is in physical communication with at least one nodule of the plurality of spaced nodules.

3. The portable computing device accessory of claim 2, wherein:
the support base and the plurality of spaced nodules are manufactured from materials selected from the group consisting of: a thermosetting polymer with a soft durometer, a thermosetting polymer with a hard durometer, a thermoplastic polymer with a soft durometer, a thermoplastic polymer with a hard durometer, metal, and ceramics.

4. The portable computing device accessory of claim 1, wherein:
the support base is configured to support a portion of the portable computing device; and
at least one nodule of the plurality of spaced nodules is in physical communication with a portion of the surface.

5. The portable computing device accessory of claim 4, wherein:
the support base and the plurality spaced nodules are manufactured from thermally conductive materials selected from the group consisting of: a thermally conductive polymer with a soft durometer, thermally conductive polymer with a hard durometer, and metal.

6. The portable computing device accessory of claim 1, wherein the portable computing device includes one or more cables, said plurality of spaced nodules being spaced to pass said cable there between.

7. The portable computing device accessory of claim 1, wherein the array includes the plurality of spaced nodules arranged in a substantially rectangular array having m-rows and n-columns.

8. The portable computing device accessory of claim 7, wherein m is 1.

9. The portable computing device accessory of claim 7, wherein m is greater than 1.

10. The portable computing device accessory of claim 9, wherein the even numbered rows have n-1 spaced nodules and the plurality of spaced nodules within the even numbered rows are configured offset from the spaced nodules within the odd numbered rows.

11. The portable computing device accessory of claim 7, wherein a portion of the array includes rows wherein the height of each successive row of spaced nodules is greater than the height of the preceding row.

12. The portable computing device accessory of claim 1, wherein the support base and the spaced nodules are a single object.

13. A portable computing device accessory, comprising:
a support base, and
a plurality of spaced nodules projecting from the support base and arranged in an array, each nodule having at least a nodule base physically coupled to the support base and a support portion coupled to the nodule base and distil to the support base;
wherein the array includes the plurality of spaced nodules arranged in a substantially rectangular array having m-rows and n-columns; and
wherein a portion of the array includes rows wherein the height of each successive row of spaced nodules is greater than the height of the preceding row.

14. The portable computing device accessory of claim 13, wherein:
the support base and the spaced nodules are manufactured from materials selected from the group consisting of: a thermosetting polymer with a soft durometer, a thermosetting polymer with a hard durometer, a thermoplastic polymer with a soft durometer, a thermoplastic polymer with a hard durometer, metal, and ceramics.

15. The portable computing device accessory of claim 13, wherein the portable computing device includes one or more cables, said nodules being spaced to pass said cable there between.

16. The portable computing device accessory of claim 13, wherein m is 1.

17. The portable computing device accessory of claim 13, wherein m is greater than 1.

18. The portable computing device accessory of claim 13, wherein the even numbered rows have n-1 spaced nodules and the spaced nodules within the even numbered rows are configured offset from the spaced nodules within the odd numbered rows.

19. The portable computing device accessory of claim 13, wherein a portion of the array includes rows wherein the height of each successive row of spaced nodules is greater than the height of the preceding row.

20. The portable computing device accessory of claim 13, wherein the support base and the spaced nodules are a single object.

21. A method of cooling lap-top computers, the method comprising in any order at least the acts of:
obtaining or providing multiple articles, each article comprising a substantially flat base having a first side and a second side, wherein the first side is substantially flat and the second side comprises multiple nodules projecting from the second side and arranged in an array;
advertising that the articles can be placed under at least a portion of a lap top computer and used to promote cooling of the lap top computer;
and selling the articles.

22. The method of claim 21 wherein the act of advertising that the articles can be placed under at least a portion of a lap top computer comprises advertising that the article can be placed under a rear portion of the lap top computer so that a keyboard of the lap top computer is sloped downward toward a user of the lap top computer.

23. The method of claim 21 wherein the act of obtaining or providing multiple articles comprises obtaining or providing articles wherein the array comprises multiple rows and wherein, for at least a portion of each article, a height of each successive row of spaced nodules is greater than a height of a preceding row.

24. The method of claim 21 wherein the act of obtaining or providing multiple articles comprises obtaining or providing articles having multiple nodules that each contain a slot for holding a cord, and wherein the act of advertising comprises advertising that at least one cord attached to the lap top computer can be managed by inserting the cord into at least one of the slots.

25. The method of claim 21 wherein the act of providing multiple articles comprises obtaining or providing articles wherein the base and the nodules are a single object.
